(19) United States
(12) Patent Application Publication
(10) Pub. No.: US 2003/0184887 A1
(43) Pub. Date: Oct. 2, 2003

(54) Method and apparatus for the correction of optical signal wave front distortion using fluid pressure adaptive optics

(76) Inventors: Dennis S. Greywall, Whitehouse Station, NJ (US); Peter Kurczynski, Maplewood, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/109,121

(22) Filed: Mar. 28, 2002

(51) Int. Cl. G02B 5/08; G02B 7/182

(52) U.S. Cl. 359/846; 359/878

(57) ABSTRACT

An adaptive optics system whereby at least one mirror in the system is manipulated using electrostatic force to attract and/or a restoring force to repel a portion of the mirror to a particular electrode. The attraction force is created by placing a voltage across an electrode in an array of electrodes positioned near that mirror. The restoring force is created by attaching or mechanically coupling a fluid-filled cavity to a mirror. It is thus possible to attract portions of the mirror in one instant by passing a voltage over individual electrodes associated with those portions of mirror and then, by reducing the voltage placed across those electrodes, to repel those same portions in the next instant. The spatial frequency of the deformation of a membrane mirror is thus increased, which allows the correction of more complex wave front distortion.

### FIELD OF THE INVENTION

The present invention is related generally to the correction of distortion of optical signals and, in particular, to the use of fluid pressure adaptive optics to correct that distortion.

### BACKGROUND OF THE INVENTION

There are nearly limitless uses for optical signals in many different fields for many different purposes. For example, such signals may be used in communications systems when analog or digital data is modulated upon an optical carrier signal, such as in an optical switch. Signals in such systems are then transmitted from one point to another using fiber optics or via free-space transmissions. Additionally, optical signals collected by telescopes are used in astronomy to view distant astronomical bodies and phenomena. There are also many uses for optical signals in the medical field. For example, by transmitting an optical signal into the human eye, it is possible to detect the light reflected off of the retina in that eye and then create an accurate map of the retina.

The operation of systems using optical signals may be hampered by a variety of factors. For example, distortion of a transmitted planar wave front of the light beam may occur due to any changes in the refractive properties of the medium through which the beam passes, including changes due to temperature variations, turbulence, index of refraction variations or other phenomena. This distortion may cause discrete sections of the wave front to deviate from the orthogonal orientation to the line of travel of the beam as initially transmitted. This distortion may result in significant degradation of the wave front at its destination. In free-space communications systems, any disturbance in the atmosphere between the transmission point and the receiving point may cause certain portions of the beam to move faster than others resulting in the aforementioned wave front distortion. The same is true in astronomical and medical uses. For example, when used to create a map of the human retina, wave front distortion does not typically result from atmospheric disturbance but, instead, results from the light beam passing first into, and then out of, the eye through its lens. The small imperfections on the lens and cornea distort the wave front of the beam much like the distortion seen in communications or astronomical uses. Whatever the particular use, the result is the same: distortion prevents a planar wave front of the beam from being received at its destination.

Adaptive optics uses a wave front sensor to measure phase aberrations in an optical system and a deformable mirror or other wave front compensating device to correct these aberrations. Deformable mirrors change their shape in order to bring the reflected wave front into phase. Until recently, these mirrors were typically deformed via piezoelectric drivers, mechanical screws, or other well-known methods. In recent methods, however, a deformable mirror may be actuated by a technique wherein an array of electrodes is located in electrostatic proximity to that mirror in the optical system. Electrostatic proximity means, as used herein, that by placing a voltage across these electrodes, an attractive force is created between those electrodes and the mirror. This procedure is known as electrostatic actuation. By controlling the attractive force along different portions of the mirror surface, the shape of the mirror may be altered in a known way, thereby at least partially correcting for the wave front distortion. Another adaptive optics method involves using magnetic forces to attract or repel portions of a mirror.

Systems using such deformable mirrors, however, have significant limitations. For example, mirrors in prior art adaptive optics systems, relying on electrostatic actuation to correct the shape of a wave front, cannot assume surface shapes with high spatial frequencies. Spatial frequency is defined as the total deformation possible over a given unit area. As such, spatial frequency directly relates to the complexity of deformation possible in a given unit area of the surface of the mirror. The higher the spatial frequency, the greater the possible complexity of deformation. A mirror with high spatial frequency must have a high number of discrete, independently deformable areas on the surface of the mirror. However, the electrodes in prior art mirrors not only deform the discrete portion directly above the electrode, but also indirectly deform surrounding portions of mirror. This “cross talk” limits the possible complexity of deformation of the mirror which, correspondingly, limits the amount and complexity of wave front distortion for which such mirrors can correct. Deformable mirrors using magnetic force to alter the shape of a mirror in order to correct the shape of the wave front also have significant limitations. For example, such mirrors required electric coils that, when energized, created significant heat. This heat has the effect of rendering the mirrors unsuitable for certain uses (e.g., infrared imaging) and, in extreme cases, could result in undesirable thermal stresses to various components of the system.

### SUMMARY OF THE INVENTION

The aforementioned problems related to wave front distortion correction are solved by the present invention. In accordance with the present invention, a fluid (either a liquid or a gas) is enclosed within a cavity beneath the mirror. The fluid within the cavity provides a restoring force to the mirror to counteract the electrostatic attraction caused by placing a voltage across at least one electrode in a group of electrodes located in electrostatic proximity to the mirror. It is advantageous to arrange the group of electrodes in a plane. When a voltage is placed across a single electrode in the group, the restoring force caused by the displacement of fluid will result in a narrower region of the mirror being influenced by the electrostatic attraction, relative to prior art mirrors. This narrower region of influence reduces the aforementioned cross talk between neighboring electrodes, thus allowing the mirror to assume shapes with higher spatial frequencies than prior art membrane mirrors. As a result, such mirrors can correct for a greater amount and complexity of wave front distortion.

### BRIEF DESCRIPTION OF THE DRAWING

FIG. 1 shows a prior art mirror redirecting an incoming light beam in a new direction;

FIG. 2 shows a prior art mirror wherein electrostatic force generated by a single electrode within a plane of electrodes is used to alter the shape of the mirror;

FIG. 3 shows a prior art mirror wherein a second plane of electrodes in the optical path is used to increase the degree of deformation of the mirror;

FIG. 4 shows a mirror in accordance with one embodiment of the present invention wherein a cavity filled with fluid is affixed to the mirror;

FIG. 5 shows the mirror of FIG. 4 wherein nominal voltages are placed across the electrodes to create a nominal shape of the mirror useful in optical systems; and

FIG. 6 shows the mirror of FIG. 5 wherein the shape of the mirror is deformed to correct for wave front distortion.

FIG. 7 shows a graph representing the effect of a restoring force, such as is caused by a fluid-filled cavity, on the shape of a mirror under the effect of a single electrode with a constant voltage placed across that electrode.

FIG. 8 shows a graph representing the effect of a restoring force, such as caused by a fluid-filled cavity, on the shape of a mirror under the effect of two adjacent electrodes with a constant and equal voltage placed across both electrodes.

### DETAILED DESCRIPTION OF THE INVENTION

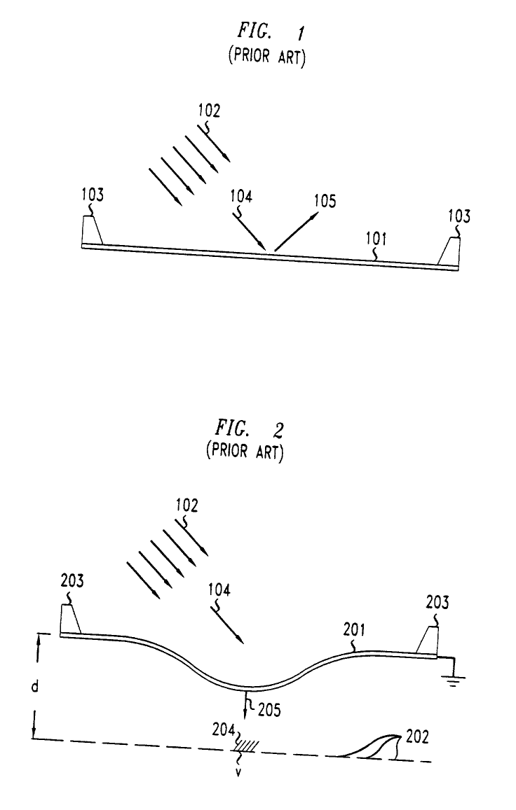

FIG. 1 shows a prior art structure utilizing a mirror 101 to reflect or focus light beam 102. Light beam 102 may be an optical signal passing through an optical network switch, an optical signal in a free-space optical communications system, light reflected from a portion of the human eye, or a light beam in any other application whereby a mirror is used to focus or alter the path of the beam. The mirror 101 may be created by etching a silicon substrate with one side of the substrate deposited with one or more layers of material such as silicon nitride, single crystal silicon, polysilicon, polyimide, or other known materials, using methods that are well known in the art.

In order to create an easily-deformable mirror, the material is typically etched, leaving side walls 103, until a membrane of as little as 1 micron remains. The membrane is reflective such that, upon reaching the mirror, light beam 102 traveling in direction 104 is reflected from the surface of the mirror and is redirected in direction 105. A metallic coating (e.g., aluminum) may be formed on this membrane to enhance reflectivity. Tension is maintained in mirror 101 by connecting side walls 103 to a supporting frame using well known methods.

As previously discussed, wave front distortion may result when any changes to the refractive properties of the transmitting medium are encountered along the line of travel 104 of the light beam. These changes may cause discrete sections of the wave front of the beam to deviate from their transmitted, orthogonal orientation to the line of travel 104 of the beam 102. The result is a distortion of the image of the wave front when it reaches its destination, which may be for example a mirror, a focal plane of a telescope, an optical wave front sensor (e.g., a curvature wave front sensor or a Shack-Hartman wave front sensor), or any other destination. By way of example, in optical communications systems, distortion may result in significant degradation of the communications signal or even the total loss of communications.

FIG. 2 shows the structure of FIG. 1 wherein electrostatic force is used to deform the reflective surface of the mirror to correct for wave front distortion of the light beam 102 in accordance with the prior art. The mirror 201 illustrated in FIG. 2 can at least partially correct for the effects of wave front distortion. By measuring the aforementioned distortion using well-known techniques, the shape of the mirror necessary to correct for that distortion is determined. The mirror 201, which is suspended between side walls 203 and is grounded, is deformed using an electrostatic force that is created by passing a voltage across at least one electrode in a plane 202 of electrodes a distance d below the mirror 201. By then selectively placing a voltage across one or more of those electrodes, such as electrode 204, located directly beneath the area of mirror 201 to be deformed, that area is attracted toward electrode 204 in direction 205. The result of passing various voltages across individual electrodes in plane 202 deforms the different sections of the mirror in a way such that, when the light beam is incident upon the mirror 201, the aforementioned wave front deformation is reduced. The aforementioned technique for correcting wave front distortion by detecting said distortion and translating that information into discrete voltages to create deformation of a mirror is well known in the art. An example of this method and apparatus, used in a free space optical communications system, is described in the co-pending U.S. patent application titled “Method and Apparatus for the Correction of Optical Signal Wave Front Distortion Within a Free-Space Optical Communications System,” having Ser. No. 09/896805, filed Jun. 29, 2001.

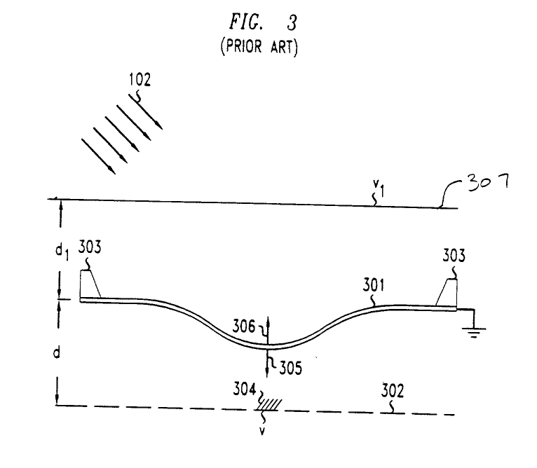

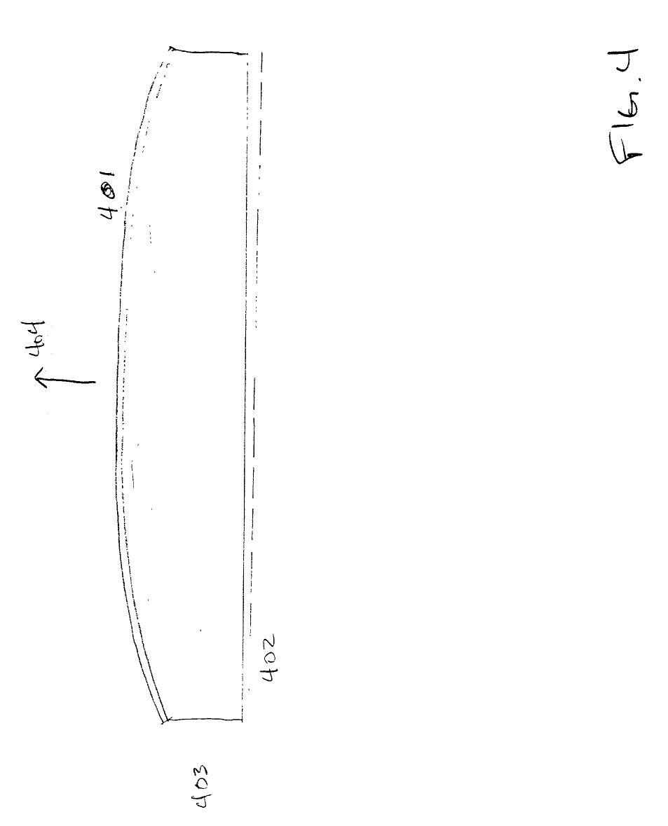

FIG. 3 shows the structure of FIG. 2 wherein the reflective surface of mirror 301, which is suspended between side walls 303 and is grounded, can compensate for a greater degree of wave front distortion than the embodiment in FIG. 2. As previously discussed, the side walls 303 are mounted to a support structure using well known methods. The greater degree of compensation afforded by the embodiment in FIG. 3 is accomplished by adding a second electrode plane 307 at a distance d₁ from that mirror on the opposite side of the mirror 301 from the first plane 302 of electrodes. As plane 307 is in the optical path of the light beam, that plane may consist of a transparent electrode, a circular electrode ring, or any other electrode type that will not significantly obstruct the path of the beam. When voltage V₁ is placed across electrode 307, mirror 301 is drawn toward that electrode in direction 306. As in the embodiment shown in FIG. 2, by passing a voltage across electrode 304, the mirror will be attracted toward that electrode in direction 305. Such a wider range of movement in either direction 305 or direction 306 facilitates correction of a greater degree of wave front distortion of the light beam 102.

Systems using the prior art mirror structures of FIGS. 1, 2, and 3 have significant limitations. For example, ideally in these systems each electrode would attract a relatively small, discrete area of that mirror when a voltage is passed across the electrode. By combining different amounts of voltage across different electrodes, a complex mirror shape would result to counter any wave front distortion present in the optical signal. However, in practice, each individual electrode does not simply effect such a discrete area, but also attracts/deforms surrounding areas. This “cross-talk” between adjacent electrodes limits attempts to form a complex mirror shape. Correspondingly, any attempt to correct for a large amount of wave front distortion, or distortion that is highly complex, is also limited.

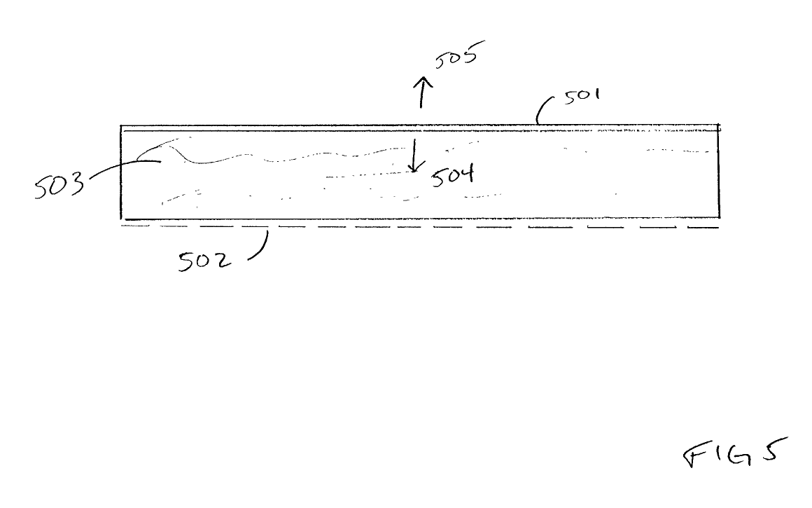

FIG. 4 shows a structure in accordance with one embodiment of the present invention wherein a fluid filled cavity 403 is positioned beneath the mirror 401. Electrodes 402 are positioned beneath mirror 401. Cavity 403 is illustratively integrated with the mirror such that the mirror or a surface affixed to the mirror forms a surface of the cavity itself. A functional equivalent to this embodiment may be achieved by placing the cavity 403 some distance away from the mirror and mechanically coupling the cavity to the mirror 401 (e.g., by inserting a material or other structure between the cavity and the mirror). The fluid 404 in cavity 403 exerts a pressure on mirror 401, illustrated by the slight bowing of the mirror in direction 404. Illustrative pressures useful to create such pressure, and hence a restorative force, are between the ranges of 100 Pa and 800 Pa. However, any pressure above or below that range that creates a restorative force on the mirror would also be beneficial and is intended to be encompassed by the present invention. Similarly, a wide range of fluids (either gas or liquid) would be useful in creating this level of pressure, providing that the fluid is electrically insulating. Thus, any use of any fluid to create a restoring force of any magnitude is intended to be encompassed by the present invention.

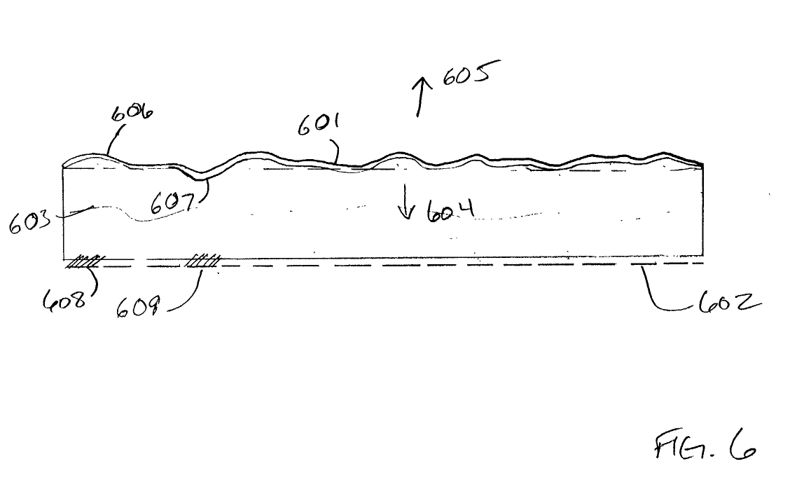

FIG. 5 shows the structure of FIG. 4 wherein a nominal voltage is passed across each electrode in the plane 502 of electrodes, thereby creating a.series of attracting electrostatic forces. Mirror 501 is thus attracted toward the electrodes 502 in direction 504 and assumes a shape that is appropriate for use in optical systems where no wave front distortion is present. Attracting the mirror toward electrodes 502 compresses the fluid in cavity 503 which, as a result, exerts a pressure on mirror 501 in direction 505. During operations of the optical system, a well-known wave front sensing and correction technique (e.g., using a Shack-Hartman or a curvature wave front sensor) is used to measure distortions in the wave front of the optical signal and to determine the deformation of mirror 501 necessary to compensate for that distortion. An exemplary discussion of the well-known techniques useful for this purpose may be found in “Wave-Front Reconstruction for Compensated Imaging,” R. H. Hudgin, Journal of the Optical Society of America, vol. 67, 1998, pp. 375-378. As previously discussed, varying the voltage across individual electrodes within plane 502 will achieve the deformation of the mirror 501. Such electrodes may be arranged advantageously in an array in a way such that, by varying voltages across multiple electrodes in the array, multiple areas on the surface of the mirror 501 can be deformed to compensate for the aforementioned wave front distortion.

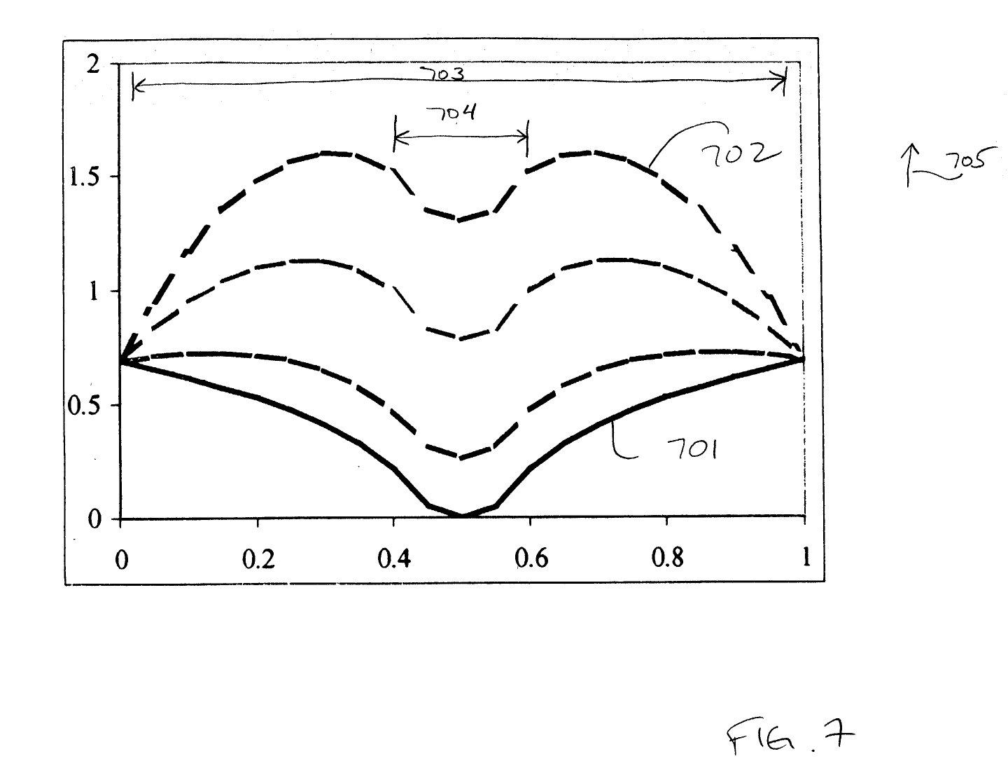

An example of such a deformed mirror is shown in FIG. 6. Using previously discussed well-known methods, wave front distortion is detected and the necessary shape of mirror 601 to compensate for the wave front distortion is determined. The shape of mirror 601 is determined by the electrostatic force created by passing voltages over individual electrodes in plane 602. By decreasing the voltage over certain electrodes, such as electrode 608, the pressure created by the fluid in the cavity 603 repels area 606 of the surface of mirror 601 away from that particular electrode in direction 605. Thus, the fluid creates a “restoring” force that acts to enhance the deformation of the mirror 601. Alternatively, some areas of the mirror, such as area 607, may need to be deformed such that they are attracted in direction 604 toward a particular electrode, such as electrode 609. This is accomplished by passing a higher voltage (as compared to the nominal state) over that particular electrode.

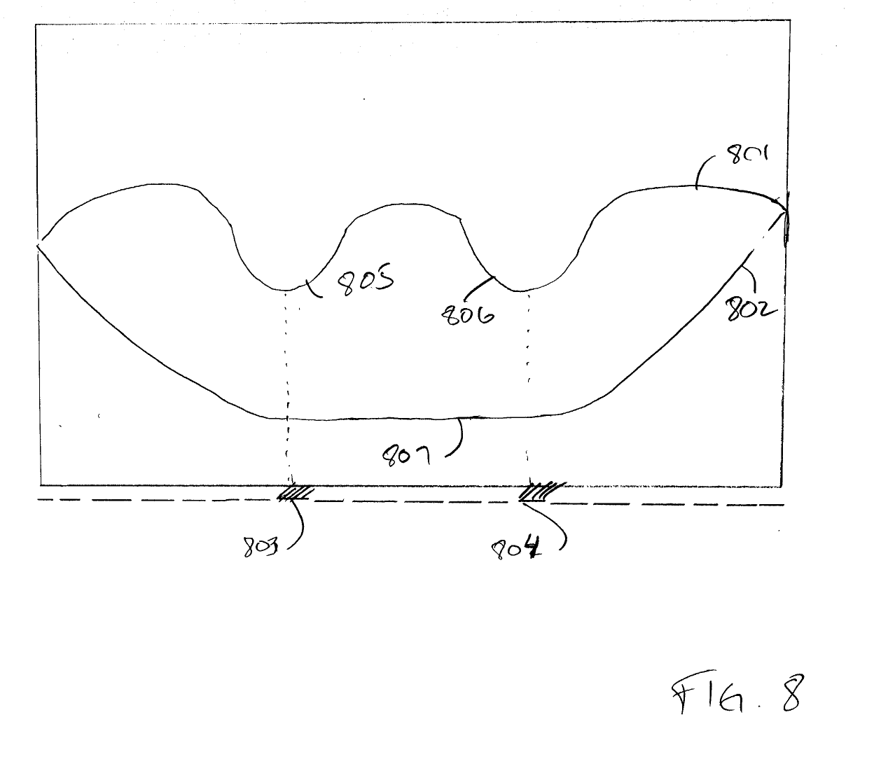

A main advantage of using a fluid as a restoring force is that such a force also limits the region that a particular electrode will influence. FIG. 7 shows a diagram of the deformation of the surface of a mirror caused by a specific electrostatic force. The different lines on the diagram represent the varying amounts of deformation that will result from that force if different restoring forces are exerted on the mirror from fluid in a cavity attached to that mirror. Line 701 shows the case where no restoring force (i.e., such as would result from a fluid-filled cavity) is exerted on the mirror in direction 705. The area of deformation 703 of the mirror represented by line 701 is wider and deeper than the mirrors represented by the other lines, which represent varying greater amounts of restoring force. Line 702 demonstrates a relatively high level of restoring force, as would exist if a significant amount of force was created by a fluid-filled cavity. The shape of this mirror is characterized by a narrower region 704 of shallower deformation.

FIG. 8 shows a graph similar to FIG. 7, but now incorporating a second electrode to demonstrate the effect of a fluid-filled cavity on the interaction between adjacent electrodes. The lines on this graph show that, for constant, equal voltages passed across electrodes 803 and 804, a greater restoring force (caused by the fluid in the cavity) will create narrower regions of influence, represented by area 805 and area 806 on the surface of the mirror 801 above each electrode 803 and 804, respectively. This results because the fluid displaced from under regions 805 and 806 directly above each electrode creates a force on the other areas of the surface of the mirror not directly above an electrode. Hence, regions 805 and 806 are less susceptible to cross-talk from electrodes 804 and 803, respectively. The mirror represented by line 802, on the other hand, experiences no restoring force and, as a result, area 807 is more susceptible to the attracting electrostatic force exerted by both electrode 804 and electrode 803. Thus, the mirror represented by line 802 is incapable of the complexity of deformation of which the mirror represented by line 801 is capable.

The foregoing merely illustrates the principles of the invention. It will thus be appreciated that those skilled in the art will be able to devise various arrangements that, although not explicitly described or shown herein, embody the principles of the invention and are within its spirit and scope. Furthermore, all examples and conditional language recited herein are intended expressly to be only for pedagogical purposes to aid the reader in understanding the principles of the invention and are to be construed as being without limitation to such specifically recited examples and conditions. Diagrams herein represent conceptual views of mirrors and light beams. Diagrams of optical components are not necessarily shown to scale but are, instead, merely representative of possible physical arrangements of such components.

What is claimed is

1. Apparatus comprising:
a deformable mirror; and
a fluid-filled cavity coupled to the mirror and exerting a restoring force on that mirror.

2. The apparatus of claim 1 further comprising means for exerting an electrostatic force upon said mirror.

3. The apparatus of claim 2 wherein said means for exerting an electrostatic force comprises a first group of electrodes disposed in electrostatic proximity to said mirror.

4. The apparatus of claim 3 wherein the group of electrodes is in an optical signal path of an optical system.

5. The apparatus of claim 3 wherein said first group of electrodes are disposed in a plane.

6. The apparatus of claim 1 wherein said fluid-cavity is integrated into the mirror.

7. The apparatus of claim 1 wherein said fluid-filled cavity is in direct physical contact with said mirror.

8. The apparatus of claim 1 wherein said fluid-filled cavity is mechanically coupled with said mirror.

9. The apparatus of claim 1 wherein said fluid-filled cavity is connected to at least one layer of a first material, said first material connected by at least one intermediate layer of a second material to at least one surface of said mirror.

10. The apparatus of claim 1 wherein said fluid-filled cavity is connected to at least one layer of a material, said material connected by at least one connecting structure to at least one surface of said mirror.

11. A method for use in an optical system comprising:
detecting wave front distortion of an optical signal;
varying, in response to the detection of said wave front distortion, a voltage across at least one electrode in said at least one group of electrodes; and
deforming a mirror in said optical system, wherein said mirror is coupled to at least one fluid-filled cavity.

12. The method of claim 11 wherein at least one group of electrodes is disposed in a plane.

13. Apparatus comprising:
a plurality of mirrors; and
a plurality of fluid-filled cavities coupled with an associated one of said mirrors.

14. The apparatus of 13 further comprising means for exerting an electrostatic force upon at least one mirror in said plurality of mirrors.

15. The apparatus of claim 14 wherein said means for exerting an electrostatic force comprises means for placing a voltage across at least one electrode in at least one group of electrodes, said group located in electrostatic proximity to at least one mirror in said plurality of mirrors.
